(19) United States
(12) Patent Application Publication
(10) Pub. No.: US 2026/0245463 A1
(43) Pub. Date: Aug. 20, 2026

(54) OPERATION MAPS GENERATION FOR ASSISTING AIRCRAFTS AT NON-TOWERED AIRPORTS

(71) Applicant: Honeywell International Inc., Charlotte, NC (US)

(72) Inventors: Karthikeyan M, Madurai (IN); Gobinathan Baladhandapani, Madurai (IN); Pradeep Huncha, Bangalore (IN); Sreenivasan Govindillam, Bangalore (IN)

(21) Appl. No.: 19/181,348

(22) Filed: Apr. 17, 2025

(30) Foreign Application Priority Data
Feb. 18, 2025 (IN) 202511014012

(51) Int. Cl. G08G 5/21; G08G 5/26; G08G 5/34; G08G 5/38; G08G 5/51; G08G 5/54; G08G 5/55; G08G 5/72; G08G 5/74; G08G 5/80

(52) U.S. Cl. CPC G08G 5/21; G08G 5/26; G08G 5/34; G08G 5/38; G08G 5/51; G08G 5/54; G08G 5/55; G08G 5/723; G08G 5/74; G08G 5/80

(57) ABSTRACT

OPERATION MAPS GENERATION FOR ASSISTING AIRCRAFTS AT NON-Approaches

for generating operations maps to assist aircraft at non-towered airports are described. According to one example, a system may receive aircraft data including performance and operational parameters. Based on the aircraft data, a cloud-based database storing information on non-towered airports is queried to retrieve historical flight path data derived from previous aircraft operations. Using the historical data and aircraft data, an operations map including aerial and ground routes is generated. The system may analyze terrain profiles, identify obstacles, and determine safe flight paths to generate the operations map. The operations map may provide guidance for approach, landing, taxi, take-off, and departure procedures tailored to specific aircraft and airport conditions. The operations map may be rendered on an aircraft's avionics display.

### BACKGROUND

Aviation operations encompass a wide range of activities conducted by various types of aircraft, from small general aviation planes to large commercial airliners. These aviation operations typically rely on a network of airports, including both towered airports with air traffic control services and non-towered airports. The towered airports utilize a navigation database for obtaining information related to standardized procedures for take-off, landing, and ground movements. The navigation database contains a list of all operational airports worldwide and published runway details. The navigation database employed by the air traffic control services relies on data obtained from official aeronautical information sources, Aeronautical Information Publications (AIPs), Notices to Airmen (NOTAMs), and other regulated sources. Thus, the air traffic control services help pilots by providing structured communication, traffic management, information about weather conditions, runway assignments, and potential conflicts, thereby enhancing safety and efficiency for all aircrafts operating within a controlled airspace.

### SUMMARY OF INVENTION

This summary is provided to introduce concepts related to assisting aircrafts with landing or take-off procedures at non-towered airports. This summary is not intended to identify essential features of the claimed subject matter nor is it intended for use in determining or limiting the scope of the claimed subject matter.

In an aspect of the present subject matter, a system for generating operations map for assisting aircrafts at non-towered airports is disclosed. The system includes a processor and a machine-readable storage medium comprising instructions executable by the processor. The instructions when executed cause the processor to receive aircraft data pertaining to one of a landing and a take-off procedure to be performed by an aircraft. In an example, the aircraft data comprises performance parameters and operational parameters of the aircraft. The performance parameters are indicative of capabilities of the aircraft and the operational parameters are indicative of a current operational state of the aircraft. The instructions when executed further cause the processor to query a cloud-based database to retrieve historical flight path data associated with a particular non-towered airport. The historical flight path data is derived from flight information of previous aircraft operations at the particular non-towered airport. In an example, the cloud-based database is configured to store information pertaining to non-towered airports. The instructions when executed further cause the processor to generate an operations map for performing one of the landing and take-off procedures at the particular non-towered airport based on the historical flight path data and the aircraft data. In an example, the operations map includes aerial and ground routes for maneuvering of the aircraft. The generated operations map may be rendered on a display of an avionic system of the aircraft.

In an aspect of the present subject matter, a method for creating a database to assist aircrafts at non-towered airports is disclosed. The method includes obtaining aviation data corresponding to a plurality of aircrafts operating at non-towered airports. The aviation data includes electronic altimeter data and historical data pertaining to one or more phases associated with a flight path of the plurality of aircrafts. The method further includes segmenting the aviation data based on each of the one or more phases at the non-towered airports. Thereafter, the method includes categorizing segmented data in each phase based on pre-defined parameters corresponding to the plurality of aircrafts. In addition, the method includes generating a flight path for each of the one or more phases at the non-towered airports based on the segmented data. The generated flight path is stored in a database for being provided to an aircraft for performing one of a landing and a take-off procedure at a selected non-towered airport.

In yet another aspect of the present subject matter, a non-transitory computer readable medium for generating operations map for assisting aircrafts at non-towered airports is disclosed. The non-transitory computer readable medium has instructions stored thereon. The instructions, when executed by a processor, cause the processor to perform operations. In the operations, a request is received from an aircraft for landing site information. The request including aircraft performance data and current location data. In addition, the instructions cause the processing resource to query a cloud-based database storing information about non-towered airports and unpublished landing sites to identify compatible landing locations based on the aircraft performance data and current location data. The instructions further cause the processing resource to retrieve historical flight path data associated with the identified compatible landing locations. The historical flight path data derived from Automatic Dependent Surveillance-Broadcast (ADS-B) information of previous aircraft operations. Using the historical flight path data, a terrain profile is generated for each of the identified compatible landing locations. The terrain profile may be analyzed to identify obstacles and determine safe approach and departure paths for each of the identified compatible landing locations. For each of the identified compatible landing locations, an operations map is created. The operations map includes the safe approach and departure paths, ground taxi routes, and identified obstacles. The operations maps may be transmitted to the aircraft for selecting a landing location from the aircraft.

### BRIEF DESCRIPTION OF FIGURES

Systems and/or methods are now described, in accordance with examples of the present subject matter and with reference to the accompanying figures, in which:

FIG. 1 illustrates a system for generating operations map for assisting aircrafts at non-towered airports, according to an example;

FIG. 2 illustrates a network environment comprising a generation system for generating operations map to assist aircrafts at non-towered airports, according to an example;

FIG. 3 illustrates a schematic block diagram of a database creation system for creating a database to assist aircrafts at non-towered airports, according to an example;

FIG. 4 illustrates a schematic block diagram of a generation system for generating operations map to assist aircrafts at non-towered airports, according to another example;

FIG. 5 illustrates an exemplary environment for assisting an aircraft in performing a landing procedure at a non-towered airport, according to an example;

FIG. 6 illustrates an exemplary environment for assisting an aircraft in performing a take-off procedure from a non-towered airport, according to an example;

FIG. 7 illustrates a method for creating a database to assist aircrafts at non-towered airports, according to another example;

FIG. 8 illustrates example method for generating operations map for assisting aircrafts at non-towered airports, according to an example;

FIG. 9 illustrates a method for generating operations map for assisting aircrafts at non-towered airports, according to another example; and

FIG. 10 illustrates a computing environment implementing a non-transitory computer-readable medium for generating operations map for assisting aircrafts at non-towered airports, according to an example.

### DETAILED DESCRIPTION

Aircraft navigation systems play a crucial role in modern aviation, providing pilots with essential information for safe and efficient flight operations. These systems typically rely on navigation databases that contain detailed information about airports, runways, and established flight procedures. Aircraft navigation systems have traditionally relied on published airport and runway information stored in navigation databases. These databases typically contain details for established airports, including runway locations, elevations, and official approach and departure procedures. However, a significant portion of aviation operations, particularly in general aviation, occur at non-towered airports. In an example, many small rural communities rely on non-towered airports for essential services, like medical evacuations, agricultural operations, and business travel. In another example, private pilots may frequently operate from the non-towered airports for recreational flying, visiting remote destinations, or accessing areas not served by larger commercial airports. However, the non-towered airports lack the dedicated air traffic control services found at the towered airports. In addition, the navigation database does not include a list of private runways and other unconventional landing sites used by general aviation aircraft thereby, presenting unique challenges for pilots.

The lack of air traffic control services may require pilots to take on extra responsibilities and handle more intricate decision-making tasks. For instance, the pilots may be required to maintain situational awareness of other aircraft in the vicinity solely through visual observation and radio communications on a common traffic advisory frequency (CTAF). This self-reliance may also extend to determining appropriate take-off and landing sequences, assessing weather conditions, and identifying potential conflicts with other aircraft or ground vehicles. The lack of standardized procedures and real-time guidance in case of the non-towered airports may lead to increased workload for pilots, particularly during high-traffic periods or in adverse weather conditions. Furthermore, the absence of radar coverage and air traffic control services at many non-towered airports means that pilots must assume full responsibility for traffic separation and situational awareness.

Moreover, non-towered airports often lack standardized approach and departure procedures, leaving pilots to navigate these critical phases of flight based on visual references and local knowledge. This can be especially challenging in low visibility conditions. The lack of comprehensive information for the unpublished landing locations may present challenges for pilots, particularly in emergency situations or when operating in unfamiliar areas. Additionally, many non-towered facilities have limited or outdated information regarding obstacles, terrain, and preferred traffic patterns, potentially compromising safety margins during operations.

To this end, approaches for generating operational maps for providing assistance to aircrafts in non-towered airports are described. The present subject matter proposes a system that leverages Automatic Dependent Surveillance-Broadcast (ADS-B) data and other connected services to create a comprehensive database of information for non-towered airports and unconventional landing sites.

In one example, aviation data corresponding to a plurality of aircrafts operating at non-towered airports may be obtained. The aviation data includes electronic altimeter data and historical data pertaining to one or more phases associated with a flight path of the plurality of aircrafts. The aviation data may be segmented based on each of the one or more phases at the non-towered airports. In an example, the one or more phases of a flight may include a take-off phase, a landing phase, and a taxi phase of an aircraft. The segmented data may be categorized in each phase based on pre-defined parameters corresponding to the plurality of aircrafts. Based on the segmented data, a flight path may be generated for each of the one or more phases at the non-towered airports. The generated flight path may be stored in a database for being provided to an aircraft for performing one of a landing and a take-off procedure at a selected non-towered airport. Thus, the present subject matter creates a database specifically curated for non-towered airports.

In an example, an aircraft may send a request to a generation system associated with the database requesting information pertaining to a landing or a take-off procedure to be performed by the aircraft. The request may include aircraft data comprising performance parameters and operational parameters of the aircraft. The performance parameters may be indicative of capabilities of the aircraft and the operational parameters may be indicative of a current operational state of the aircraft. Based on the received aircraft data, the generation system may query a cloud-based database to retrieve historical flight path data associated with a particular non-towered airport from the cloud-based database. The historical flight path data is derived from flight information of previous aircraft operations at the particular non-towered airport. Based on the historical flight path data and the aircraft data, the generation system may generate an operations map for performing the landing or the take-off procedures at the particular non-towered airport. The operations map includes aerial and ground routes for maneuvering of the aircraft. The operations map is rendered at an avionic system of the aircraft.

Accordingly, by collecting and analyzing historical flight data, virtual departure and arrival procedures tailored to each specific location may be generated. The present subject matter may provide pilots with valuable guidance similar to what would be received at towered airports, even when operating in non-controlled environments. In addition, usage of radio altimeters and onboard cameras to create up-to-date terrain and obstacle maps for these locations enhances pilots' situational awareness, allowing for safer operations in varying conditions. The operations map generated for taxiways at non-towered airports provides crucial information about ground navigation. By providing pilots with detailed, empirically-derived information about non-towered airports and landing sites, the present subject matter enhances safety in general aviation operations. Furthermore, the cloud-based nature of the database allows for continuous updates and wide accessibility, ensuring that pilots always have access to the most current and relevant information.

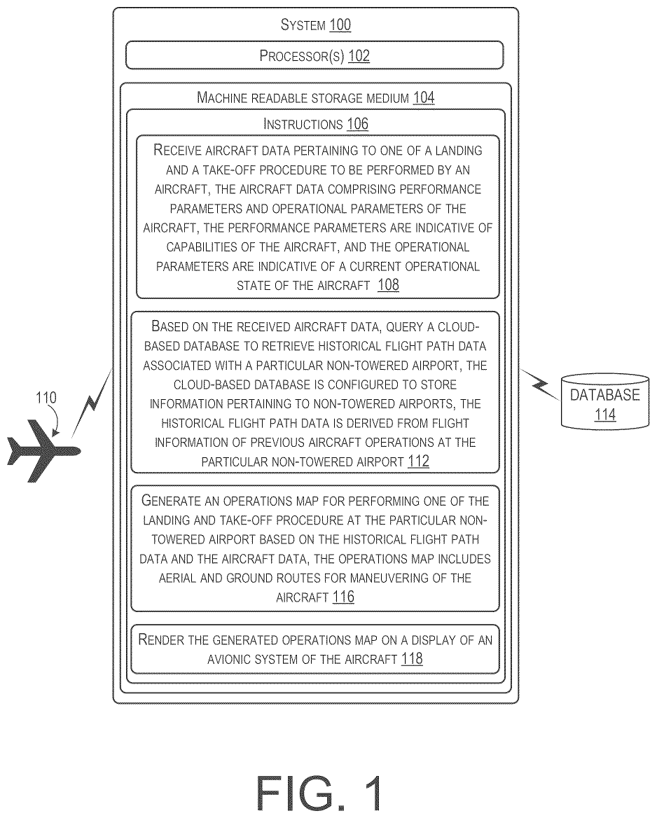

The present subject matter is further described with reference to FIG. 1 to FIG. 10. It should be noted that the description and figures merely illustrate principles of the present subject matter. Various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof.

FIG. 1 illustrates a system 100 for generating an operations map for assisting aircrafts at non-towered airports, according to an example. As used herein, the term “non-towered airports” may refer to airports, airfields, or landing sites that do not have an operational control tower or dedicated air traffic control services. These facilities may include public or private airports, airstrips, and other landing areas where pilots are responsible for their own traffic separation, communication, and decision-making regarding take-off and landing operations. Non-towered airports may range from established rural or community airports to improvised or infrequently used landing sites, and may serve general aviation, recreational flying, agricultural operations, emergency services, or other specialized aviation activities.

The system 100 may be implemented in various forms to assist aircraft operations at the non-towered airports. In one example, the system 100 may be a ground-based system that processes and stores data from multiple sources. For example, the system 100 may collect and analyse data from receivers positioned near non-towered airports, aggregating flight path information from numerous aircraft operations over time. In another example, the system 100 may be a cloud-based service that an aircraft may connect to via datalink or satellite communication. This configuration may allow for real-time updates and access to the latest information about non-towered airports and landing sites.

In an example, the system 100 may also be integrated into existing avionics suites or electronic flight bags (EFBs) aboard aircraft. The system 100 may accordingly work in conjunction with onboard systems to provide pilots with seamless access to non-towered airport information and generated operations maps. In some cases, the system 100 may be part of a larger network that includes both ground stations and airborne units. This distributed architecture may enable data sharing and updates across multiple platforms, enhancing the overall accuracy and timeliness of the information provided. The system 100 may also be implemented as a standalone unit that may be installed in general aviation aircraft, providing smaller operators with advanced capabilities for operating at non-towered airports.

The system 100 may include a processor 102 and a machine-readable storage medium 104 which is coupled to, and accessible by, the processor 102. The processor 102 may be implemented as a dedicated processor, a shared processor, or a plurality of individual processors, some of which may be shared. The processor(s) 102 may include microprocessors, microcomputers, microcontrollers, digital signal processors, central processing units, state machines, logic circuitries, and/or any other devices that manipulate signals and data based on computer-readable instructions. Further, functions of the various elements shown in the figures, including any functional blocks labelled as “processor(s)”, may be provided through the use of dedicated hardware as well as hardware capable of executing computer-readable instructions.

The machine-readable storage medium 104 may be communicatively connected to the processor 102. Among other capabilities, the processor 102 may fetch and execute computer-readable instructions, including instructions 106, stored in the machine-readable storage medium 104. The machine-readable storage medium 104 may include non-transitory computer-readable medium including, for example, volatile memory such as RAM (Random Access Memory), or non-volatile memory such as EPROM (Erasable Programmable Read Only Memory), flash memory, and the like. The instructions 106 may be executed to classify the hardware components of the computing device.

In an example, the processor 102 may fetch and execute the instructions 106. In one example, as a result of the execution of the instructions 108, the system 100 may receive aircraft data pertaining to one of a landing and a take-off procedure to be performed by an aircraft 110. As may be understood, the landing and take-off procedures are to be performed at a non-towered airport. The non-towered airports may vary in infrastructure and capabilities. Some non-towered airports may include paved runways with basic lighting and wind indicators, while other non-towered airports may have unpaved grass or dirt strips with minimal facilities. In some scenarios, the non-towered airports may be unconventional landing sites not officially designated as airports but used by general aviation aircraft in specific circumstances.

Further, the aircraft data includes performance parameters and operational parameters of the aircraft 110. In an example, the performance parameters are indicative of capabilities of the aircraft 110. The performance parameters may include factors such as maximum take-off weight, landing distance requirements, climb rate capabilities, stall speeds at various configurations, maximum crosswind component for safe operations, minimum runway length requirements, service ceiling, range and endurance capabilities, aircraft category, and so on.

In addition, the operational parameters may be indicative of a current operational state of the aircraft 110. Examples of the operational parameters may include, but are not limited to, current aircraft weight, fuel quantity remaining, current altitude and airspeed, heading and ground track, vertical speed, outside air temperature, wind direction and speed at aircraft's position, equipment status, and current phase of flight (e.g., cruise, descent, approach). By considering both performance and operational parameters, the system 100 may provide tailored assistance that accounts for both the aircraft's inherent capabilities and its current operational state, enabling more accurate and relevant guidance for operations at non-towered airports.

Upon receiving the aircraft data, the instructions 112 may be executed to query a cloud-based database 114 based on the received aircraft data. In an example, the cloud-based database 114 is configured to store information pertaining to non-towered airports. The cloud-based database 114 may contain a comprehensive collection of data about various non-towered airports, including locations of the non-towered airports, runway characteristics, terrain features, historical usage patterns, and other relevant information.

To this end, the instructions 112 may be executed such that historical flight path data associated with a particular non-towered airport may be retrieved from the cloud-based database. The historical flight path data may be derived from fight information of previous aircraft operations at the particular non-towered airport. In an example, the historical flight path data retrieved from the cloud-based database 114 may include a comprehensive record of aircraft movements at the particular non-towered airport over a specified period of time, such as past 6 months or past 12 months. The historical flight path data may encompass various aspects of flight operations, such as approach paths, landing trajectories, taxi routes, take-off patterns, and departure procedures. The historical flight path data may be collected from multiple sources, including but not limited to ADS-B transmissions, radar data, and pilot reports. In some aspects, the historical flight path data may also include information about seasonal variations, weather-related adjustments to flight paths, and differences in operations between various aircraft types and categories.

Additionally, the instructions 116 may be executed to generate an operations map for performing one of the landing and the take-off procedure at the particular non-towered airport based on the historical flight path data and the aircraft data. The operations map includes aerial and ground routes for maneuvering of the aircraft. To generate the operations map, the system 100 may analyze the historical data in conjunction with the aircraft data, to identify recurring patterns, preferred approach angles, commonly used ground movement paths, and potential obstacles or areas of concern.

The operations map may include recommended approach and departure paths, preferred traffic patterns, suggested taxi routes, and potential areas to avoid based on terrain or obstacles. The operations map may be tailored to the specific performance capabilities and current operational state of the aircraft 110, as indicated by the aircraft data. For instance, the operations map may adjust recommended approach angles or runway usage based on the aircraft's weight, size, and current weather conditions. In an example, the system 100 may dynamically update the generated operations map in real-time to reflect changing conditions or new information received by the system 100.

Further, the instructions 118 may be executed to render the generated operations map on a display of an avionic system of the aircraft 110. In some aspects, the system 100 may render the operations map on the display of the aircraft's avionic system, providing the pilot with a visual representation of the recommended procedures and routes for the particular non-towered airport. This visual guidance may enhance situational awareness and assist in decision-making during critical phases of flight at these less-structured airfields. The rendered operational map may include interactive elements, allowing the pilot to zoom in on specific areas, toggle different layers of information, or access additional details about particular features of the non-towered airport.

Accordingly, the present subject provides assistance for aircraft operations at non-towered airports. By leveraging historical flight data and real-time aircraft information, the system 100 may enhance safety, improve situational awareness, and facilitate efficient decision-making. The system 100 may integrate seamlessly with existing avionics thereby supporting operations at unconventional landing sites. The present subject matter therefore enables pilots to operate more safely and efficiently in less-structured airport environments, benefiting from the collective experience of previous operations.

The above functionalities performed as a result of the execution of the instructions 106 may be performed by different programmable entities. Such programmable entities may be implemented through any computing systems, which may be implemented either on a single computing device, or multiple computing devices. As will be explained, various examples of the present subject matter are described in the context of a computing system which creates a database containing information about non-towered airports and generates operational maps to assist aircrafts. These and other examples are further described with respect to the remaining figures.

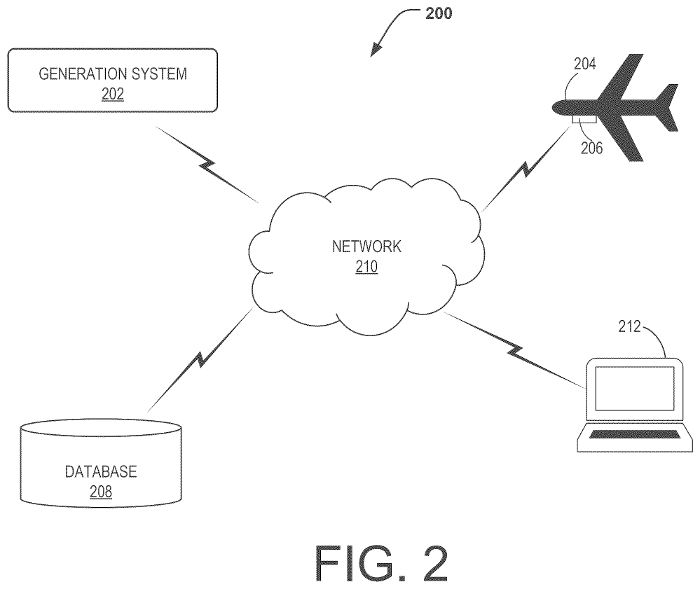

FIG. 2 illustrates a network environment 200 comprising a generation system 202 for generating operations map to assist an aircraft 204 at non-towered airports, according to an example. The generation system 202 may be similar to the system 100 and may operate to communicate with the aircraft 204, create a set of compatible non-towered airports, generate operational map for a selected non-towered airport, and render the operational map onboard the aircraft 204 during flight. The generation system 202 may be implemented by any computing device that includes at least one processor, a memory, a user interface, and a communication hardware.

In an example, the generation system 202 may be located onboard the aircraft 204 and may communicate with the one or more communication devices 206 via wired or wireless communication connections. Alternatively, the generation system 202 may be at a remote location and may communicate with the communication device(s) 206 onboard the aircraft 204 and a cloud database 208 via a network 210. Unlike traditional navigation databases, the cloud database 208 may serve as a comprehensive repository for non-towered and unpublished airport information, including historical flight data, runway information, and operational parameters.

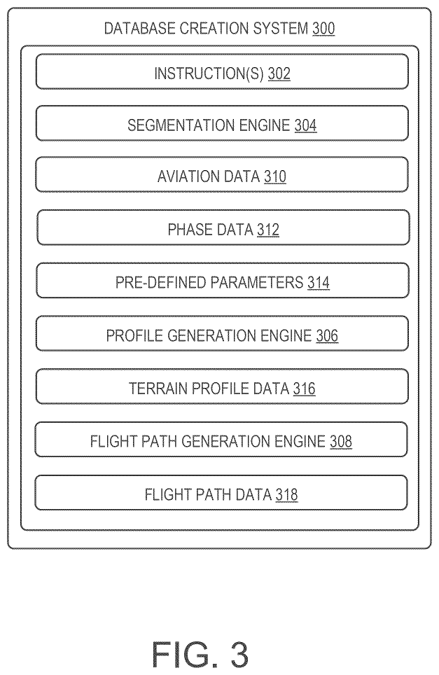

In an example, the network environment 200 includes a database creation system 212 to create and maintain the cloud database 208. The database creation system 212 may collect and maintain Automatic Dependent Surveillance Broadcast (ADS-B) data from various sources, including but not limited to, receivers at non-towered airports and commercial ADS-B service providers like FlightRadar24. The database creation system 212 may process the data through post-flight analytics, segment the data based on flight phases and categorize the data based on aircraft types and flight dates. The database creation system 212 may continuously update the database 208 with real mission data, the database 208 stores essential information, such as coordinates, elevation, mission dates, and external characteristics. The database creation is further explained in conjunction with FIG. 3. In an example, certain embodiments of the network environment 200 may include additional or alternative elements and components, as desired for the particular application.

The cloud database 208 may store detailed information on unpublished landing sites, approach and departure procedures, and taxiways. The cloud database 208 may also incorporate obstacle details, suitable landing spots, and other relevant information captured by radio altimeters and cameras (installed on aircrafts). For each flight segment, the database 208 includes performance-specific trajectories, including data on fuel consumption and time.

The network 210 may be a satellite communication network enabling global connectivity for aircraft in flight, aeronautical radio network, like the Aeronautical Mobile Satellite Service (AMSS), facilitating air-to-ground communications, ground-based radio network, such as very high frequency (VHF) or high frequency (HF) radio systems used for air traffic control communications, Internet-based network using secure protocols for ground-based systems and operations, combination of multiple network types to ensure redundancy and global coverage.

During operation, the aircraft 204 may communicate with the generation system 202 to request assistance in performing landing or take-off procedures at a non-towered airport. In an example, the generation system 202 may receive requirements from the aircraft 204 and may create a set of compatible non-towered airports based on the requirements of the aircraft 204. As used herein, the term “compatible” may refer to non-towered airports that meet the specific operational needs and constraints of the aircraft 204. The compatibility of the aircraft 204 may be determined based on various factors, such as runway length, width, and surface type, airport elevation, surrounding terrain, available approach paths, and so on. The generation system 202 may analyze these factors against the data stored in the cloud database 208 to identify airports that may safely accommodate the aircraft 204.

The generation system 202 may share the set of compatible non-towered airports with the communication system 206 of the aircraft 204. In an example, a pilot of the aircraft 204 may select one non-towered airport from the set of non-towered airports. Thereafter, the generation system 202 may retrieve relevant information, such as but not limited to, historical flight paths, obstacle data, and airport characteristics, about the selected airport from the cloud database 208. Using this information, the generation system 202 may generate a customized operations map tailored to the specific aircraft's capabilities and the current operational conditions of the aircraft 204. An operations map in the context of the present subject matter may refer to a comprehensive visual guide generated for aircraft operations at a selected non-towered airport. The operations map may integrate aerial and ground routes, encompassing recommended approach and departure paths, taxiing routes, and key navigational reference points.

By leveraging aggregated data from previous aircraft operations, the operations map may provide guidance for pilots to safely and efficiently conduct landings, take-offs, and ground movements at facilities without control towers. The operations map may adapt to the unique characteristics of each aircraft and airport, offering a customized solution for navigating the challenges of uncontrolled airspace.

FIG. 3 illustrates a schematic block diagram of a database creation system 300 for creating a database to assist aircrafts at non-towered airports, according to an example. The database creation system 300 (hereinafter referred to as creation system 300) may be similar to the database creation system 212. The creating system 300 comprises a processor or memory (not shown), for analyzing and storing information pertaining to non-towered airports to generate operational maps to assist aircrafts to perform either a landing procedure or a take-off procedure at the non-towered airports.

The creation system 300 may further include instructions 302, a segmentation engine 304, a profile generation engine 306, and a flight path generation engine 308. In an example, the instructions 302 are fetched from a memory and executed by a processor included within the creation system 300. The segmentation engine 304, the profile generation engine 306, and the flight path generation engine 308 may be implemented as a combination of hardware and programming, for example, programmable instructions to implement a variety of functionalities. In examples described herein, such combinations of hardware and programming may be implemented in several different ways. For example, the programming for the segmentation engine 304, the profile generation engine 306, and the flight path generation engine 308 may be executable by instructions, such as the instructions 302. Such instructions may be stored on a non-transitory machine-readable storage medium which may be coupled either directly with the creation system 300 or indirectly (for example, through networked means). In an example, the segmentation engine 304, the profile generation engine 306, and the flight path generation engine 308 may include a processing resource, for example, either a single processor or a combination of multiple processors, to execute such instructions. In the present examples, the non-transitory machine-readable storage medium may store instructions, such as the instructions 302, that when executed by the processing resource, implement the segmentation engine 304, the profile generation engine 306, and the flight path generation engine 308. In other examples, the segmentation engine 304, the profile generation engine 306, and the flight path generation engine 308 may be implemented as electronic circuitry.

The instructions 302 when executed by the processing resource, cause the segmentation engine 304 to obtain aviation data, such as the aviation data 310, corresponding to a plurality of aircrafts operating at non-towered airports. In an example, the segmentation engine 304 may obtain aviation data 310 pertaining to all airports and thereafter filter the aviation data to isolate flights operating at non-towered airports. In this example, the segmentation engine 304 may compare the take-off and landing locations against a navigation database (NAVDB) to identify operations at airports not listed in official databases.

The segmentation engine 304 may obtain the aviation data 310 from various sources, such as ADS-B receivers, ADS-B flight tracking services, or other aviation data providers. As used herein, the term “aviation data” may refer to information related to aircraft operations, flight characteristics, and environmental conditions. For example, the aviation data 310 may include ADS-B transmissions, flight plans, radar data, pilot reports, and historical flight records collected from various sources, such as onboard systems, ground-based sensors, and air traffic management databases. In some cases, the aviation data 310 may also include aircraft type, performance characteristics, weather conditions, and time of day for each recorded flight.

In addition to the above, the aviation data 310 may include electronic altimeter data and historical data pertaining to a flight path of the plurality of aircrafts. In an example, the segmentation engine 304 may obtain data from onboard altimeters that use radio waves to determine an aircraft's height above sea level or ground level. Further, the historical data may include information from various flights operating at the non-towered airports over an extended period, allowing the creation system 300 to build a comprehensive database of aircraft operations at the non-towered airports. The historical data may offer insights into typical flight patterns, commonly used approach and departure routes, and preferred operational procedures at specific non-towered airports. Thus, the aviation data 310 may enable the creation system 300 to analyze patterns, trends, and typical flight behaviors at the non-towered airports, forming the foundation for generating standardized procedures and flight paths.

Once obtained, the segmentation engine 304 may segment the aviation data 310 based on one or more phases associated with the flight path of the plurality of aircrafts. The one or more phases may refer to distinct stages of an aircraft's journey from departure to arrival. These phases may broadly include, but are not limited to, taxi phase, take-off phase, and landing phase. Each phase may be associated with specific operational parameters, altitude ranges, speed profiles, or navigational requirements that are relevant to the particular stage of flight. Accordingly, the segmentation engine 304 may examine changes in altitude, speed, and position of the plurality of aircrafts over time and may analyze the ADS-B data to identify different phases of flight.

For example, the segmentation engine 304 may identify the taxi phase when an aircraft is moving on the ground at low speeds, the take-off phase when there is a rapid increase in ground speed and altitude, and so on. The segmentation engine 304 may also consider other factors, such as geographical location, proximity to known airports, and aircraft type to refine the phase identification process. The segmentation engine 304 may store the data pertaining to the one or more phases as phase data 312. The phase data 312 may include time stamps, duration, altitude ranges, speed profiles, and other relevant parameters for each identified phase.

Once the aviation data 310 is segmented based on different phases, the segmentation engine 304 may categorize the phase data 312 based on pre-defined parameters 314 corresponding to the plurality of aircrafts. Examples of the plurality of pre-defined parameters 314 may include, but are not limited to, aircraft type and category, runway dimensions such as length and width, weather conditions, aircraft performance parameters, and fuel status. In an example, the segmentation engine 304 may dynamically adjust the categorization based on new data or changing conditions.

For example, the segmentation engine 304 may categorize the segmented data according to aircraft categories. These categories may be based on various aircraft characteristics such as size, weight, performance capabilities, or equipment specifications. For example, the segmentation engine 304 may group data for light single-engine aircraft separately from data for larger multi-engine aircraft or jets.

In an example, the segmentation engine 304 may use various tools for categorizing the phase data 312 based on the pre-defined parameters 314. Examples of the tools may include data clustering techniques to group similar flight paths based on shared characteristics or patterns, statistical analysis tools to identify trends and correlations within the flight data, pattern recognition algorithms to identify recurring flight path behaviors across different aircraft types, time series analysis tools to categorize data based on temporal patterns, and so on.

Further, the profile generation engine 306 may generate terrain profile for each of the plurality of non-towered airports. In an example, the profile generation engine 306 may generate the terrain profile based on the aviation data captured by the radio altimeter readings from multiple aircraft operating at a non-towered airport. For instance, as an aircraft approaches or departs, the radio altimeter of the aircraft may continuously measure the height above ground level. The profile generation engine 306 may aggregate the radio altimeter data from multiple aircrafts to create a three-dimensional model of the terrain.

In another example, profile generation engine 306 may obtain camera images from the aircrafts to identify potential obstacles near the non-towered airports. For instance, analysis of camera footage may reveal a newly constructed cell tower at a distance from the runway. The profile generation engine 306 may add the cell tower as an obstacle in the model of the terrain. In addition, the profile generation engine 306 may take into account seasonal changes that may affect airport operations. For example, based on the seasonal changes, the profile generation engine 306 may note that at a coastal airstrip, during spring tides, the approach end of the runway is occasionally submerged. This information may be included in the terrain profile, alerting pilots to potential hazards during certain times of the year. The profile generation engine 306 may store the model of the terrain as terrain profile data 316.

The profile generation engine 306 may also map a surrounding terrain, beyond an immediate non-towered airport, to assist with approach and departure planning. For example, in a mountain valley airport, the profile generation engine 306 may include details of ridge lines and peaks surrounding the airport in the terrain profile data 316. Such details may help pilots to plan safe approach and departure routes that avoid terrain conflicts. By combining the radio altimeter data, camera images, and the ADS-B tracking of successful landings, the profile generation engine 306 may identify optimal touchdown zones on the runway of a non-towered airport.

By processing and combining various data sources, the profile generation engine 306 may create comprehensive, dynamic profiles of non-towered airports. These profiles may provide pilots with crucial information for safe operations, especially at unfamiliar or challenging locations.

In an example, the flight path generation engine 308 may analyze the phase data 312 to identify patterns and trends in aircraft operations at the non-towered airports. For instance, the flight path generation engine 308 may examine approach paths, touchdown points, taxi routes, and departure procedures commonly used by different aircraft types. Such analysis may take into account factors, such as prevailing winds, terrain features, and obstacles in the vicinity of the non-towered airports.

Based on the analysis, the flight path generation engine 308 may generate flight paths for various phases of flight at each non-towered airport. As mentioned earlier, the phases may include approach, landing, taxi, take-off, and departure. For example, in case of approach and landing phases, the flight path generation engine 308 may design flight paths that provide a stabilized approach to the runway, taking into account factors such as descent rate, and runway alignment. In the case of taxi routes, the flight path generation engine 308 may analyze the historical data to identify commonly used paths between runways, taxiways, and parking areas based on the ground movement. This may help in creating standardized taxi procedures that enhance safety and efficiency on the ground at non-towered airports.

Likewise, for take-off and departure phases, the flight path generation engine 308 may generate flight paths that provide safe obstacle clearance while optimizing climb performance. The flight path generation engine 308 may also incorporate seasonal variations and time-of-day considerations into the generated flight paths. For example, the flight path generation engine 308 may create separate procedures for day and night operations or adjust flight paths based on seasonal changes in prevailing winds.

In an example, the flight path generation engine 308 may create multiple flight path options for each phase to accommodate different aircraft types, weather conditions, and operational scenarios. In generating these flight paths, the flight path generation engine 308 may utilize the terrain profile data 316 to ensure that the proposed flight paths avoid terrain conflicts and known obstacles. In addition, the flight path generation engine 308 may consider the pre-defined parameters 314, such as aircraft performance capabilities, to tailor the flight paths to specific aircraft categories. The flight path generation engine 308 may store information pertaining to the flight paths as flight path data 318.

In some cases, the flight path generation engine 308 may employ machine learning algorithms to continuously refine and improve the generated flight paths based on new data received from aircraft operations at the non-towered airports. This adaptive approach may allow the system to respond to changes in airport conditions, aircraft performance capabilities, or operational trends over time.

The generated flight paths may be stored in a database, such as the cloud database 208 for later use by aircraft performing landing or take-off procedures at selected non-towered airports. The generated flight paths may be stored in a database, potentially within the cloud database 208, for later retrieval and use by aircraft performing landing or take-off procedures at selected non-towered airports. These standardized procedures may provide pilots with valuable guidance for operating safely and efficiently at unfamiliar non-towered airports, enhancing overall aviation safety.

In an example, the cloud-based database may incorporate advanced indexing techniques to facilitate rapid querying and retrieval of flight paths based on multiple criteria. These indices may be optimized for common search parameters such as airport identifier, aircraft type, runway, and weather conditions. Further, to ensure data freshness, the cloud-based database may employ an automated updating mechanism. The updating mechanism may periodically refresh the stored flight paths based on new data inputs, such as recent flight operations or changes in airport conditions. The update frequency may be dynamically adjusted based on the rate of new data acquisition for each non-towered airport.

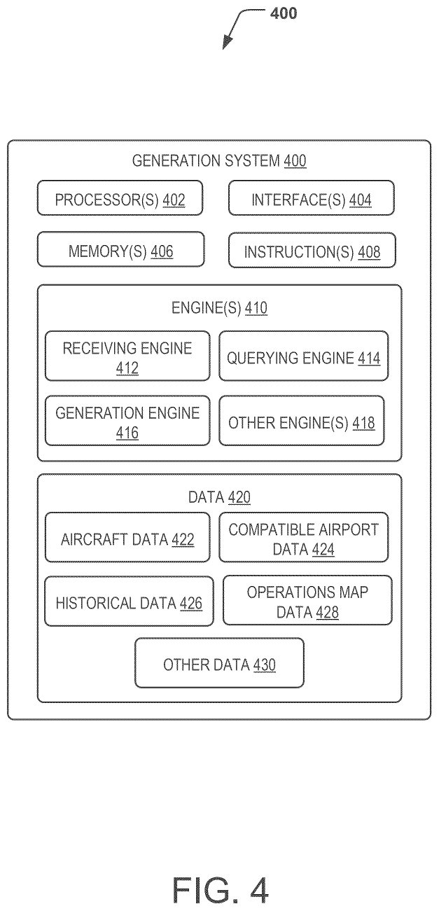

FIG. 4 illustrates a schematic block diagram of a generation system 400 for generating operations map to assist aircrafts at non-towered airports, according to another example. The generation system 400 may be similar to the generation system 202. In an example, the generation system 400 may query a database based on performance and operational parameters associated with an aircraft. The generation system 400 may generate an operations map for safe landing or take-off procedures of the aircraft.

The generation system 400 includes processor(s) 402 similar to the processor(s) 102. Further, the generation system 400 includes interface(s) 404 and memory(s) 406. The interface(s) 404 may allow the connection or coupling of the generation system 400 with one or more other devices, through a wired (e.g., Local Area Network, i.e., LAN) connection or through a wireless connection (e.g., Bluetooth®, Wi-Fi). The interface(s) 404 may also enable intercommunication between different logical as well as hardware components of the generation system 400.

The memory 406 may be a computer-readable medium, examples of which include volatile memory (e.g., RAM), and/or non-volatile memory (e.g., Erasable Programmable read-only memory, i.e., EPROM, flash memory, etc.). The memory 406 may be an external memory, or internal memory, such as a flash drive, a compact disk drive, an external hard disk drive, or the like. The memory 406 may further include data which either may be utilized or generated during the operation of the generation system 400.

Similar to the system 100, the generation system 400 may further include instructions 408 and engine(s) 410. In an example, the instructions 408 are fetched from the memory 406 and executed by the processor 402 included within the generation system 400. The engine(s) 410 may include a receiving engine 412, a querying engine 414, a generation engine 416, and other engine(s) 418. The other engine(s) 418 may further implement functionalities that supplement functions performed by the generation system 400 or any of the engine(s) 410. The receiving engine 412, the querying engine 414, and the generation engine 416 may be implemented as a combination of hardware and programming, for example, programmable instructions to implement a variety of functionalities.

In examples described herein, such combinations of hardware and programming may be implemented in several different ways. For example, the programming for the receiving engine 412, the querying engine 414, and the generation engine 416 may be executable instructions, such as instructions 408. Such instructions 408 may be stored on a non-transitory machine-readable storage medium which may be coupled either directly with the generation system 400 or indirectly (for example, through networked means). In an example, the receiving engine 412, the querying engine 414, and the generation engine 416 may include a processing resource, for example, either a single processor or a combination of multiple processors, to execute such instructions. In the present examples, the non-transitory machine-readable storage medium may store instructions, such as instructions 408, that when executed by the processing resource, implement the receiving engine 412, the querying engine 414, and the generation engine 416. In other examples, the input engine 412, the labelling engine 414, and the rendering engine 416 may be implemented as electronic circuitry.

The generation system 400 may further include data 420. The data 420 may include corresponding data that is utilized or generated by the generated system 400, while performing a variety of functions. In an example, the data 420 further includes valid aircraft data 422, compatible airport data 424, historical data 426, operations map data 428, and other data 430. Further, the other data 430, amongst other things, may serve as a repository for storing data that is processed, or received, or generated as a result of the execution of the instructions by the processor 402.

In operation, the receiving engine 412 may receive the aircraft data 422 pertaining to landing and take-off procedures to be performed by an aircraft. The aircraft data 422 may include performance parameters, of the aircraft, which may indicate the aircraft's capabilities. Examples of the performance parameters may include but are not limited to, maximum take-off weight, landing distance requirements, and climb performance of the aircraft. In addition, the aircraft data 422 may include operational parameters, of the aircraft, which may indicate a current operational state of the aircraft. Examples of the operational parameters may include, but are not limited to, current fuel levels, payload, and weather conditions at the aircraft's location.

In an example, the receiving engine 412 may receive the aircraft data 422 directly from the aircraft, such as the aircraft 204 through a communication network. The data transmission between the aircraft and the generation system 400 may occur via datalink, satellite communication, or other airborne connectivity methods. Considering an example where an aircraft may be en route from New York to Miami when the aircraft encounters unexpected severe weather conditions. A pilot of the aircraft may determine that a diversion to a nearby non-towered airport may be necessary for safety reasons. Thus, the pilot may send a request through an avionics system of the aircraft to the generation system 400 for assistance in landing at the non-towered airport. The request may include the aircraft data 422, such as current position and altitude of the aircraft, remaining fuel quantity, aircraft type and performance characteristics (e.g., landing distance required, maximum crosswind limitations), number of passengers and cargo weight, etc.

In another example, the receiving engine 412 may receive the aircraft data 422 from a relay network of other aircraft in the vicinity that may intercept and forward ADS-B signals from the aircraft in distress to the generation system 400. This airborne relay network may extend the range of data transmission beyond the coverage of ground stations, enabling the receiving engine 412 to obtain critical information about the aircraft's position, altitude, velocity, and other parameters even in remote or oceanic areas where direct communication coverage may be limited.

In yet another example, the receiving engine 412 may receive the aircraft data 422 from ground-based radar systems that may capture transponder signals from the aircraft, providing crucial information such as aircraft's unique identifier, altitude, and position, which may then be transmitted to the generation system 400 for processing and analysis in emergency situations.

Based on the received aircraft data 422, the querying engine 414 may analyze the performance parameters and operational parameters to determine specific requirements of the aircraft for landing or take-off. The analysis may involve processing various aspects of the aircraft's capabilities and current state. For example, for the performance parameters, the querying engine 414 may consider the aircraft's specific model (such as a Boeing 737-800), aircraft's maximum take-off weight (such as 174,200 pounds), aircraft's landing distance requirement (such as about 5,000 feet at sea level under standard conditions), maximum crosswind limitation (such as 35 knots), and a climb gradient capability of the aircraft (such as 500 feet per nautical mile).

With respect to the operational parameters, the querying engine 414 may determine current fuel levels of the aircraft (such as about 15,000 pounds), payload of aircraft that may include passengers and cargo (such as 30,000 pounds), and weather conditions at the aircraft's location (such as headwinds of 20 knots with moderate rainfall). The querying engine 414 may accordingly calculate the aircraft's current weight based on fuel and payload and compare the calculated weight to a maximum allowable weight for safe operations. Based on the above example, the querying engine 414 may calculate the aircraft's current weight as 150,000 pounds, factoring in the fuel, payload, and the aircraft's empty weight.

The querying engine 414 may synthesize the information to determine the specific requirements for a suitable airport. For instance, the querying engine 414 may calculate the minimum runway length needed based on the aircraft's current weight, performance capabilities, and environmental conditions. For example, the querying engine 414 may determine that, given the current weight and weather conditions, the aircraft requires a minimum runway length of 6,500 feet. The querying engine 414 may determine that the aircraft may require an increased length to account for the wet runway due to rainfall. Further, the querying engine 414 may determine a maximum allowable airport elevation based on the aircraft's climb performance and current weight. For example, based on the mentioned performance and operational parameters, the querying engine 414 may determine that the maximum allowable airport elevation for a safe approach and potential go-around is about 3,000 feet above sea level.

Accordingly, the querying engine 414 may formulate a query that incorporates these specific requirements. The query may include parameters, such as the calculated minimum runway length, the determined airport elevation limits, and a specified radius of proximity to the aircraft's current position. The querying engine 414 may also include other relevant factors in the query, such as runway surface type (e.g., paved or unpaved), availability of instrument approach procedures, and fuel services. Again referring to the above example, the querying engine 414 may formulate a query to find non-towered airports within a 100-nautical mile radius of the aircraft's current position that have a runway of at least 6,500 feet in length, an elevation not exceeding 3,000 feet above sea level, and a runway alignment that would result in a crosswind component of less than 35 knots given the current wind conditions.

The querying engine 414 may execute the query on a cloud-based database, such as the database 208. As described with reference to FIG. 2, the cloud-based database 208 may store information related to non-towered airports, including historical flight path data, runway information, and operational parameters.

Based on the query, the querying engine 414 may access the database to retrieve relevant information based on the specific requirements of the aircraft. The querying engine 414 may create a set of compatible non-towered airports for performing the landing procedure by the aircraft. In an example, the querying engine 414 may employ a multi-step process to create the set of compatible non-towered airports based on the specific requirements of the aircraft. Initially, the querying engine 414 may filter the database to identify all non-towered airports within a certain radius of the aircraft's current position or intended destination. This radius may be dynamically adjusted based on factors such as the aircraft's remaining fuel, current weather conditions, and operational urgency.

Once a preliminary set of airports is identified, the querying engine 414 may apply more specific filters based on the aircraft's performance parameters and operational parameters. For runway length requirements, the querying engine 414 may consider the aircraft's current weight, performance capabilities, and environmental factors such as altitude and temperature to calculate the minimum required runway length. The querying engine 414 may then eliminate airports with runways shorter than this calculated length from the list of potential options to create the set of compatible non-towered airports. In an example, the set of compatible non-towered airports generated by the querying engine 414 may be continuously updated as the aircraft's position or conditions change. This dynamic approach ensures that pilots always have access to the most current and relevant options for their operations at non-towered airports.

After the querying engine 414 creates the set of compatible non-towered airports, the set is shared with the aircraft. In an example, the querying engine 414 may communicate with the aircraft through various wireless communication technologies and protocols. This transmission may occur through various communication channels, such as datalink, satellite communication, or other airborne connectivity methods. For example, the querying engine 414 may communicate with the aircraft through satellite-based communication systems, very high frequency (VHF) data links (VDL), Automatic Dependent Surveillance-Broadcast (ADS-B) networks, and so on.

In an example, the set of compatible non-towered airports may be displayed on the avionic system as a list view, showing the compatible airports in order of suitability or proximity. In another example, the set of compatible non-towered airports may be presented as a map showing the aircraft's current position and the locations of compatible non-towered airports. Each non-towered airport may be represented by an icon, with color-coding to indicate suitability or other relevant factors.

For example, a display of the avionic system of the aircraft may show a dynamic, zoomable map centered on the aircraft's current position. The map may use different colors or shading to represent various terrain features, bodies of water, and airspace boundaries. Each compatible non-towered airport may be represented by a distinct icon on the map. The map may display range rings centered on the aircraft's position to help pilots quickly gauge distances to various airports. These rings may be adjustable based on the aircraft's current range capabilities.

In addition, the set of compatible non-towered airports presented to the aircraft may include relevant details for each airport, such as runway lengths, current weather conditions, distance from the aircraft's position, and any other pertinent information that could aid in decision-making. When the pilot hovers over or selects an airport icon, a pop-up window or sidebar may appear, providing key information about that airport without leaving the map view.

The pilot may then review the set of compatible non-towered airports and select a most suitable non-towered airport based on their assessment of the current situation, mission requirements, and personal judgment. The selection may be made through an avionics interface of the aircraft and transmitted back to the generation engine 416. In some cases, the querying engine 414 may also provide a recommended airport based on additional factors, such as fuel efficiency or estimated time of arrival, while still allowing the pilot to make the final decision. The selection process may be iterative, with the pilot able to request additional information about specific airports before making a final choice.

In response to the pilot selection, the generation engine 416 may interact with the cloud database 208 to retrieve historical data 428 related to previous flight operations at the selected non-towered airport. The historical data 428 may include information about typical flight paths, commonly used approach and departure routes, and preferred operational procedures at specific non-towered airports. The generation engine 416 may receive the historical flight path data associated with the selected non-towered airport. The generation engine 416 may analyze the historical data 428 to identify patterns, common approach and departure routes, and typical aircraft behaviors at the non-towered airport.

Using the historical data 428, the generation engine 416 may identify frequently used flight paths and patterns, determine common approach and departure routes, analyze typical altitudes, speeds, and trajectories used by aircraft, recognize potential obstacles or terrain features that affect flight paths, identify preferred taxi routes on the ground, and so on. Thus, the generation engine 416 may process the historical data 428 in conjunction with current aircraft data, weather conditions, and airport information to generate an operations map for the aircraft. In other words, the generation engine 416 may analyze the aircraft data 422 and the historical data 426 to create the operations map. The operations map may be stored by the generation engine 416 as the operations map data 430. The operations map data 430 may include standardized procedures for various phases of flight, such as approach, landing, taxi, take-off, and departure, tailored to the specific aircraft and non-towered airport. In addition, the operations map may include suggested aerial and ground routes that are based on successful past operations at the non-towered airport, enhancing safety and efficiency for the current flight.

In an example, the generation engine 416 may process additional information to enhance the operations map. The additional information may include incorporating real-time weather data, NOTAMs (Notices to Airmen), or other similar data that could affect flight operations at the non-towered airport. The generation engine 416 may utilize the additional information to generate the operations map. Once the operations map is generated, the generation engine 416 may render the generated operations map on the display of the avionic system of the aircraft.

The generation system 400 of the present subject matter offers several advantages for aircraft operations at non-towered airports. For example, by analyzing aircraft data and airport information, the generation system 400 may enhance safety by helping pilots make more informed decisions about landing and take-off procedures at unfamiliar locations. The querying engine's 414 ability to continuously update the set of compatible non-towered airports as conditions change ensures pilots have access to current and relevant options. The generation engine 416 may create tailored operations maps based on specific aircraft capabilities and operational parameters, potentially improving efficiency. Visual representation of compatible airports and the operations maps on the aircraft's avionics display may enhance pilot situational awareness during critical decision-making processes. Utilizing a cloud database for storing and accessing airport information may allow for rapid updates and consistent data across multiple users and platforms. By considering multiple factors such as runway length, airport elevation, and current weather conditions, the generation system 400 may provide a comprehensive assessment of airport suitability for specific aircraft operations.

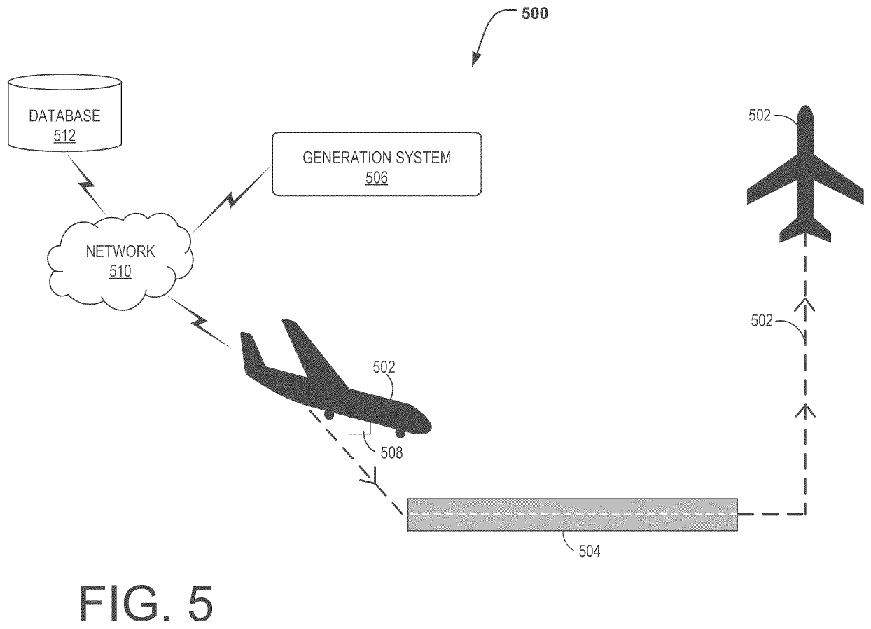

FIG. 5 illustrates an exemplary environment 500 for assisting an aircraft 502 in performing a landing procedure at a non-towered airport 504, according to an example. The environment 500 may include a generation system 506 to assist the aircraft 502 during an emergency landing at the non-towered airport 504, by processing and managing flight data. In an example, the aircraft 502 may be equipped with an avionic system 508 that may communicate aircraft data.

For example, when the aircraft 502 encounters a situation requiring immediate landing, the avionic system 508 may transmit aircraft data to the generation system 506 via a cloud network 510. The aircraft data may include the aircraft's current position, altitude, fuel status, aircraft type, and the nature of the emergency. In an example, the generation system 506 may receive weather information from local sensors or regional weather services through the cloud network 510.

Upon receiving this information, the generation system 506 may query a database 512 through the cloud network 510. The database 512 may contain comprehensive data about non-towered airports, including runway lengths, widths, surface types, elevation, surrounding terrain, and historical weather patterns. The generation system 506 may also access real-time weather data and NOTAMs (Notices to Airmen) to ensure the most up-to-date information is considered.

Based on the querying, the generation system 506 may identify a set of compatible non-towered airports for the emergency landing. In an example, the generation system 506 may consider various parameters, such as distance from the aircraft's current position, runway length and width in relation to the aircraft's requirements, runway surface condition and type, surrounding terrain and obstacles, current and forecasted weather conditions, available emergency services in the vicinity, and historical flight paths of similar aircraft types at the airports. In addition, the generation system 506 may provide estimated time of arrival and fuel consumption predictions for each potential landing site to aid the pilot's decision-making process.

The generation system 506 may then transmit the set of compatible non-towered airports to the aircraft's avionic system 508 through the cloud network 510. A pilot of the aircraft 502 may review the options presented on the avionic system 508 and may select a most suitable airport based on their assessment of the current situation and the provided information.

Once the pilot makes a selection, the generation system 506 may receive this input and generate a detailed operations map for a chosen non-towered airport 504. The operations map may include an optimal approach path, taking into account factors like the aircraft's glide ratio, wind conditions, and terrain avoidance. The generation system 506 may also consider the aircraft's remaining fuel to ensure that the aircraft 502 may reach the chosen airport safely. In an example, the operations map could include alternative approach paths in case the primary approach becomes unavailable due to changing conditions or obstacles.

The generated operations map, along with relevant airport information, is transmitted back to the aircraft's avionic system 508 through the cloud network 510. As the aircraft 502 approaches the selected non-towered airport 504, the avionic system 508 may display real-time guidance based on this information. Upon landing, the operations map may also provide taxi path guidance. The generation system 506 may consider factors such as the specific runway used for landing, known taxiway conditions and widths, location of parking areas or emergency services, potential obstacles on the ground, and historical taxi patterns of similar aircraft at this airport. This taxi guidance helps the pilot navigate safely on the ground, even without air traffic control assistance.

Throughout the landing procedure, the generation system 506 may continuously interact with the database 512. It may pull additional data as needed, such as detailed airport diagrams or updated weather information. The generation system 506 may also push data, such as the actual flight path and taxi route 514 taken by the aircraft 502, back to the database. This data may be used to refine future recommendations, continuously improving the system's accuracy and effectiveness in assisting aircraft at non-towered airports.

As the aircraft 502 completes the landing, the avionic system 508 may record the actual flight path taken, including any adjustments made by the pilot. In addition, the avionic system 508 may capture data about the aircraft's ground movements, including the taxi route 514 taken after landing. This data may be transmitted back to the database 512 through the cloud network 510. The generation system 506 may analyze this information to refine any future recommendations for similar aircraft types or under similar conditions.

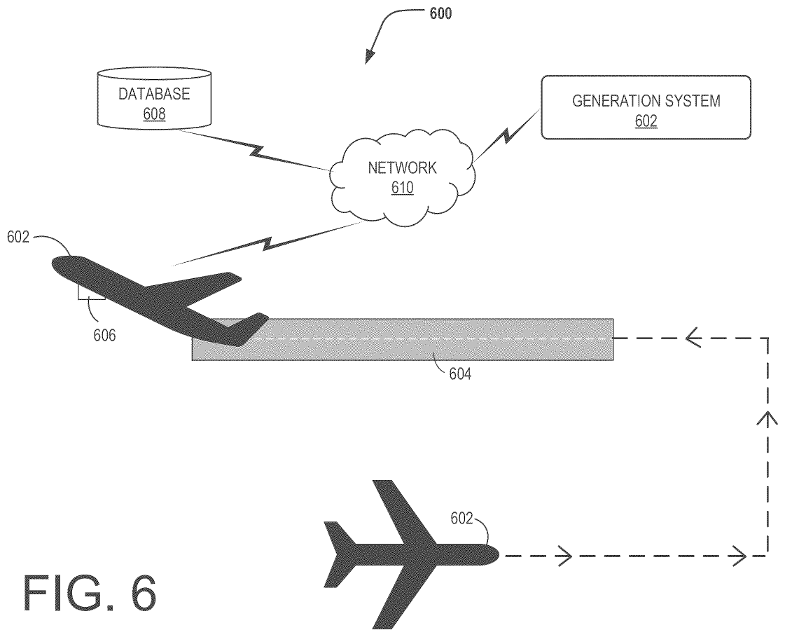

FIG. 6 illustrates an exemplary environment 600 for assisting an aircraft 602 in performing a take-off procedure at a non-towered airport 604, according to an example. The environment 600 may include a generation system 606 to assist the aircraft 602 during an emergency take-off at the non-towered airport 604, by processing and managing flight data. In this scenario, the aircraft 602, equipped with an avionic system 608, prepares for departure from a non-towered airport where traditional air traffic control services are unavailable.

Prior to take-off, the pilot of the aircraft 602 may use the avionic system 608 to send a request to the generation system 606 via the communication network 610. This request may include the aircraft's current location, destination, aircraft type, weight, and other relevant operational parameters. The generation system 606 may receive this information and initiate the process of creating a tailored take-off procedure for the aircraft 602.

As explained earlier, the generation system 606 may query a cloud database 612 through the communication network 610 to retrieve relevant information about the non-towered airport and its surroundings. This may include runway characteristics, terrain data, obstacle information, current and forecasted weather conditions, and historical take-off patterns of similar aircraft from this airport. The cloud database 612 may continuously update its information based on data collected from various sources, including previous aircraft operations at the airport. In an example, the generation system 602 may query the cloud database 612 to create a set of compatible alternate non-towered airports in the vicinity. This information could be useful for the pilot in case of any unforeseen issues during or immediately after take-off.

The generation system 606 may consider factors such as distance, runway length, facilities, and current weather conditions to identify suitable alternate airports. This set of compatible airports may be transmitted to the aircraft 602 along with the tailored take-off plan, allowing the pilot to have a comprehensive understanding of their options in case of an emergency or change in plans.

Using the retrieved data and the aircraft's specific parameters, the generation system 606 may generate an operations map. The operations map may include the optimal runway for take-off based on current wind conditions, a recommended take-off path that considers terrain and obstacles, and a suggested initial climb profile. The generation system 606 may also provide information on any specific procedures or considerations unique to the non-towered airport. The generation system 606 may transmit the operations map back to the aircraft 602 through the communication network 610. The avionic system 608 may receive this information and display the same to the pilot through a display. Displaying the information may include a visual representation of the take-off path, critical decision points, and any areas to avoid during the initial climb.

As the aircraft 602 begins to take-off, the avionic system 608 may continue to receive real-time updates from the generation system 606. These updates may include any last-minute changes in wind conditions or newly reported obstacles. The pilot may use this information to make any necessary adjustments to the take-off procedure. In an example, after becoming airborne, the generation system 606 may continue to provide guidance for the initial climb and departure from the airport vicinity. This may include recommended headings and altitudes to maintain separation from terrain, obstacles, and potentially other aircraft operating in the area. The generation system 606 may also suggest optimal routes to transition into the en-route phase of flight or to join established air traffic routes.

Throughout the take-off procedure, the aircraft 602 may transmit its position and performance data back to the generation system 606 via the communication network 610. The generation system 606 may use this information to update the cloud database 612, refining the historical data for future operations at this non-towered airport. This continuous feedback loop helps improve the accuracy and effectiveness of the system for subsequent aircraft using the same airport.

By leveraging the network environment 600, the generation system 606 provides crucial support for safe and efficient take-off operations at non-towered airports, enhancing situational awareness and decision-making capabilities for pilots operating in these challenging environments.

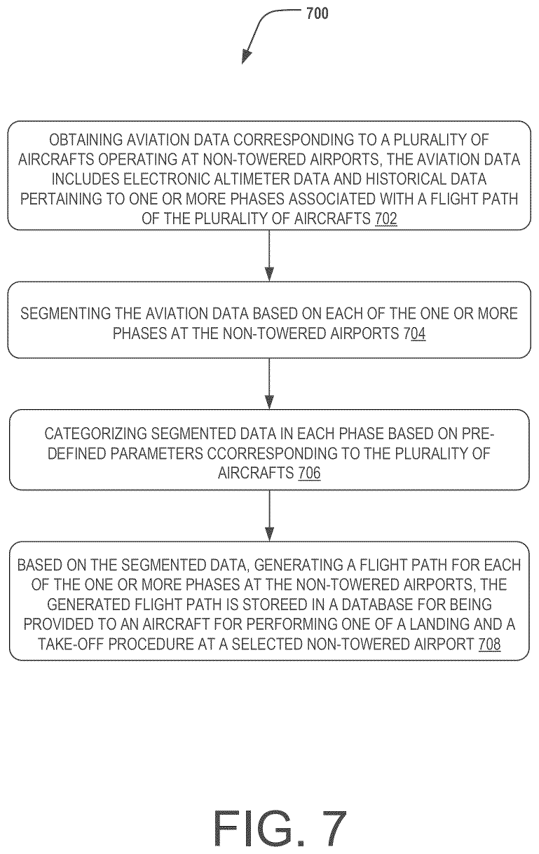

FIG. 7 illustrates example method 700 for creating a database to assist aircrafts at non-towered airports, according to an example. The order in which the method is described is not intended to be construed as a limitation, and any number of the described method blocks may be combined in any order to implement the methods, or an alternative method. Further, the method 700 may be implemented by processing resource or computing device(s) through any suitable hardware, non-transitory machine-readable instructions, or combination thereof.

It may also be understood that method 700 may be performed by programmed computing devices, such as the system 212 and 300, as depicted in FIGS. 1 and 3. Furthermore, the method 700 may be executed based on instructions stored in a non-transitory computer-readable medium, as will be readily understood. The non-transitory computer-readable medium may include, for example, digital memories, magnetic storage media, such as one or more magnetic disks and magnetic tapes, hard drives, or optically readable digital data storage media. While the method 700 is described below with reference to the system 100 and 400 as described above; other suitable systems for the execution of these methods may also be utilized. Additionally, implementation of the method is not limited to such examples.

Referring to FIG. 7, at block 702, the method 700 includes obtaining aviation data corresponding to a plurality of aircrafts operating at non-towered airports. The aviation data includes electronic altimeter data and historical data pertaining a flight path of the plurality of aircrafts. The aviation data may be collected from various sources, such as ADS-B receivers, radio altimeters, or commercially available ADS-B flight tracking services. The historical data may include information about origin, destination, aircraft category details, and other relevant flight parameters. In an example, the historical flight data may be Automatic Dependent Surveillance-Broadcast (ADS-B) data.

At block 704, the method 700 may include segmenting the aviation data based one or more phases associated with the flight path of the plurality of aircrafts. In an example, these phases may include approach, landing, taxi, takeoff, and departure. The segmentation process may involve analyzing altitude profiles, speed variations, and position data to identify distinct flight phases.

At block 706, the method 700 may include categorizing segmented data in each phase based on pre-defined parameters corresponding to the plurality of aircrafts. These parameters may include aircraft type, performance characteristics, weight class, or other relevant factors that influence flight patterns. This categorization may help in creating standardized procedures for different aircraft types operating at the non-towered airport.

At block 708, the method 700 may include, based on the segmented data, generating a flight path for each of the one or more phases at the non-towered airports. The generated flight path is stored in a database for being provided to an aircraft for performing one of a landing and a take-off procedure at a selected non-towered airport. These generated flight paths may represent typical approach and departure procedures, as well as ground movement patterns such as taxi routes.

In an example, generating the flight path may include creating a terrain profile associated with a non-towered airport. The terrain profile may be developed using various data sources, such as satellite imagery, LiDAR scans, or topographical maps. For example, creating the terrain profile may include filtering the radio altitude data to remove noise from the radio altitude data for the non-towered airport and interpolating the flight path to fill gaps in the radio altitude data. In an example, filtering the radio altitude data may include applying statistical techniques or signal processing algorithms to distinguish between genuine terrain features and spurious data points that may result from atmospheric interference, equipment limitations, or other sources of noise. The database creation system 300 may employ various filtering techniques, such as moving average filters, median filters, and Kalman filtering. These filtering techniques may help smooth out irregularities in the data while preserving important terrain features.

After filtering, the database creation system 300 apply interpolation techniques to estimate terrain elevations in areas where direct measurements are unavailable. Interpolation techniques, such as linear interpolation, spline interpolation, may be used to fill any gaps, creating a continuous terrain profile.

Once the terrain profile is created, the terrain profile may be compared with a pre-defined threshold value to determine if there are any obstacles above the terrain profile. The threshold value may be set based on safety regulations, aircraft performance characteristics, or other relevant factors. The comparison process may involve analyzing the terrain profile data point by point or in segments to identify any areas that exceed the threshold. Upon determination that a portion of the terrain profile is above the threshold value, the database creation system 300 may generate the flight path for the non-towered airport taking into account these identified obstacles. This generation process may involve adjusting approach and departure angles, specifying minimum altitudes for different segments of the flight path, or creating waypoints to guide aircraft around obstacles.

The database may be continuously updated with new data, allowing for refinement of the generated flight paths over time. The stored flight paths may be filtered based on criteria such as recency of use, distance from the airport, and compatibility with different aircraft categories. This information may then be made available through avionics displays or other navigation systems to assist pilots in planning and executing operations at non-towered airports, enhancing safety and efficiency in these environments.

The method 700 may further include receiving a request from an avionic system of an aircraft for arrival at a non-towered airport. The request may be initiated by the pilot or automatically generated by the aircraft's navigation system when approaching a destination area. The request may comprise information pertaining to the aircraft, such as its current position, altitude, speed, fuel status, aircraft type, performance characteristics, and intended destination. Additional information in the request may include weather conditions, pilot preferences, or any special requirements for the landing.

Based on the information provided in the request, the method 700 may include extracting a set of non-towered airports from the database. The extraction may involve querying the database using various criteria derived from the aircraft information. For example, data pertaining to non-towered airports within a certain radius of the aircraft's current position or intended destination may be extracted from the database, considering factors such as runway length requirements for the specific aircraft type, fuel range, and other relevant parameters. The extracted set may include multiple non-towered airports that potentially meet the basic criteria for the aircraft's landing needs.

The method 700 may also include filtering the extracted set of non-towered airports based on one or more parameters indicated in the request. The filtering may involve applying additional criteria to refine the selection of suitable landing sites. Parameters used for filtering may include proximity to the intended destination, current and forecasted weather conditions at each airport, availability of services or facilities required by the aircraft or crew, terrain considerations, and historical usage patterns of the airports. After applying these filters, a final set of results may be generated, representing the most suitable non-towered airports for the aircraft's arrival. The final set of results may then be rendered on the avionic system, providing the pilot with a clear and concise display of the available options for landing at a non-towered airport.

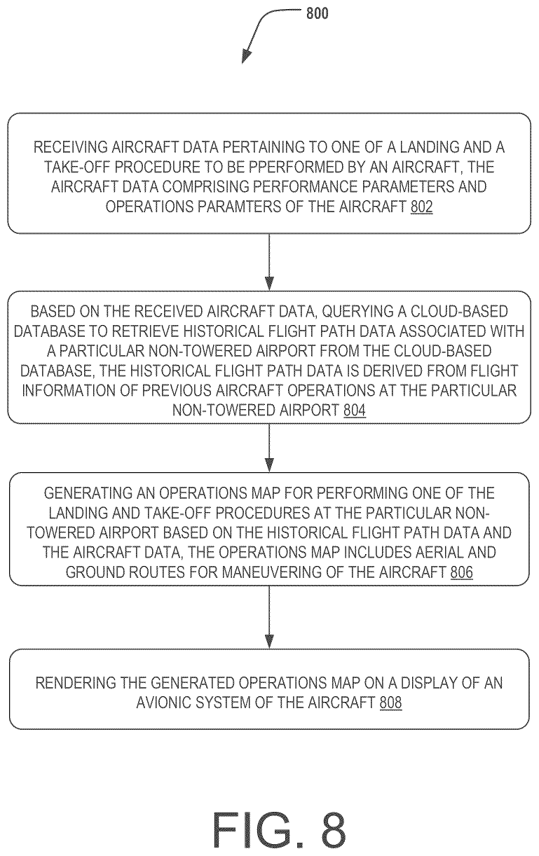

FIG. 8 illustrates example method 800 for generating operations map for assisting aircrafts at non-towered airports, according to an example. It may also be understood that method 700 may be performed by programmed computing devices, such as the system 100 and 400, as depicted in FIGS. 1 and 4. The present example method illustrates generation of operations map for assisting an aircraft in performing landing or take-off procedures.

At block 802, the method 800 includes receiving aircraft data pertaining to one of a landing and a take-off procedure to be performed by an aircraft. The aircraft data comprising performance parameters and operational parameters of the aircraft. In an example, the performance parameters are indicative of capabilities of the aircraft, and the operational parameters are indicative of a current operational state of the aircraft. In an example, the receiving engine 412 may receive the aircraft data. The performance parameters may include factors such as maximum take-off weight, landing distance requirements, climb rate capabilities, stall speeds at various configurations, maximum crosswind component for safe operations, minimum runway length requirements, service ceiling, range and endurance capabilities, and aircraft category. The operational parameters may include current aircraft weight, fuel quantity remaining, current altitude and airspeed, heading and ground track, vertical speed, outside air temperature, wind direction and speed at aircraft's position, equipment status, and current phase of flight.

At block 804, the method 800 includes based on the received aircraft data, querying a cloud-based database to retrieve historical flight path data associated with a particular non-towered airport from the cloud-based database. The cloud-based database is configured to store information pertaining to non-towered airports. Further, the historical flight path data is derived from flight information of previous aircraft operations at the particular non-towered airport. In an example, the querying engine 414 may query the cloud-based database. The cloud-based database may contain a comprehensive collection of data about various non-towered airports, including locations, runway characteristics, terrain features, and historical usage patterns. The historical flight path data may encompass various aspects of flight operations, such as approach paths, landing trajectories, taxi routes, take-off patterns, and departure procedures. This data may be collected from multiple sources, including ADS-B transmissions, radar data, and pilot reports, and may cover a specified period of time, such as the past 6 or 12 months.

At block 806, the method 800 includes generating an operations map for performing one of the landing and take-off procedures at the particular non-towered airport based on the historical flight path data and the aircraft data. The operations map includes aerial and ground routes for maneuvering of the aircraft. In an example, the generating engine 416 may generate the operations map. The generating engine 416 may analyze the historical flight path data in conjunction with the aircraft data to identify recurring patterns, preferred approach angles, commonly used ground movement paths, and potential obstacles or areas of concern. The operations map may include recommended approach and departure paths, preferred traffic patterns, suggested taxi routes, and potential areas to avoid based on terrain or obstacles. The operational map may be tailored to the specific performance capabilities and current operational state of the aircraft, as indicated by the aircraft data. For instance, the operations map may adjust recommended approach angles or runway usage based on the aircraft's weight, size, and current weather conditions.

At block 808, the method 800 includes rendering the generated operations map on a display of an avionic system of the aircraft. In an example, the generation engine 416 may render the operations map on the display. The rendered operations map may provide the pilot with a visual representation of the recommended procedures and routes for the particular non-towered airport. This visual guidance may enhance situational awareness and assist in decision-making during critical phases of flight at these less-structured airfields. In some cases, the rendered operational map may include interactive elements, allowing the pilot to zoom in on specific areas, toggle different layers of information, or access additional details about particular features of the non-towered airport. The system may also dynamically update the generated operations map in real-time to reflect changing conditions or new information received by the system.

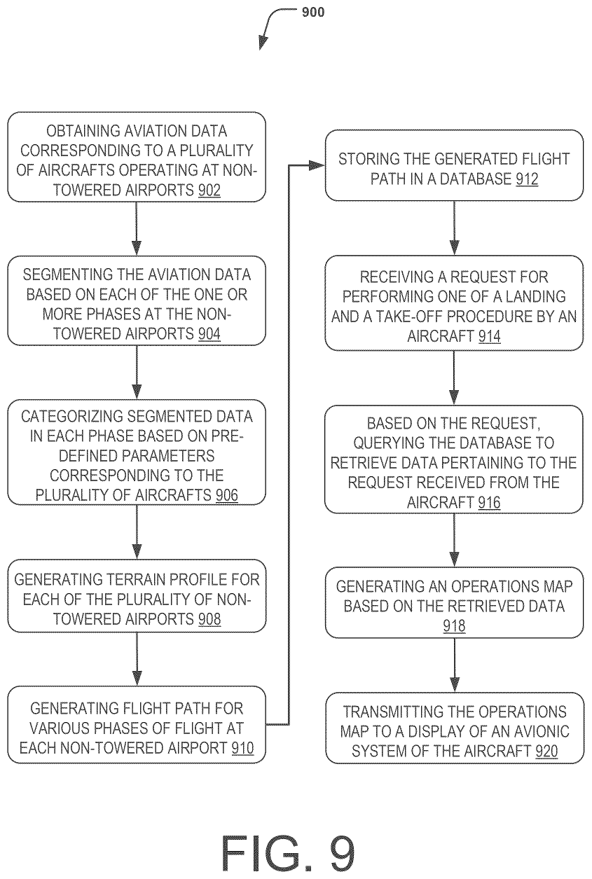

FIG. 9 illustrates example method 900 for generating operations map for assisting aircrafts at non-towered airports, according to another example. The order in which the method is described is not intended to be construed as a limitation, and any number of the described method blocks may be combined in any order to implement the methods, or an alternative method. Further, the method 900 may be implemented by processing resource or computing device(s) through any suitable hardware, non-transitory machine-readable instructions, or combination thereof. It may also be understood that method 900 may be performed by programmed computing devices, such as the systems 300 and 400, as depicted in FIGS. 3 and 4. While the method 900 is described below with reference to the systems 300 and 400 as described above; other suitable systems for the execution of these methods may also be utilized. Additionally, implementation of the method is not limited to such examples.

Referring to FIG. 9, at block 902, the method 900 may include obtaining aviation data corresponding to a plurality of aircrafts operating at non-towered airports. In an example, the aviation data may be obtained by collecting data from various sources such as ADS-B receivers, flight tracking services, and onboard aircraft systems. The aviation data may include flight trajectories, altitudes, speeds, aircraft types, and timestamps. In some cases, the data collection may also incorporate information from ground-based weather stations, pilot reports, and local airport management systems to provide a comprehensive view of the operational environment. In an example, the segmentation engine 304 may obtain the aviation data corresponding to a plurality of aircraft operating at the non-towered airports.

At block 904, the method 900 may include segmenting the aviation data based on each of the one or more phases at the non-towered airports. In an example, the segmentation engine 304 may analyze the obtained aviation data to identify and separate distinct flight phases such as approach, landing, taxi, take-off, and departure for each aircraft operation at the non-towered airports. The segmentation engine 304 may use advanced algorithms to analyze altitude profiles, speed changes, and position data to accurately identify distinct flight phases such as approach, landing, taxi, take-off, and departure. The segmentation may account for variations in aircraft performance and non-standard traffic patterns often encountered at non-towered airports.

At block 906, the method 900 may include categorizing the segmented data in each phase based on pre-defined parameters corresponding to the plurality of aircrafts. In an example, the segmentation engine 304 may be responsible for not only segmenting the aviation data into different flight phases, but also for categorizing the segmented data based on pre-defined parameters. Examples of the pre-defined parameters may include, but are not limited to, aircraft type, weight class, performance characteristics, and equipment capabilities. The categorization may be an extension of the segmentation task, allowing for more refined organization and analysis of the flight data for each phase of operation at the non-towered airports.

At block 908, the method 900 may include generating a terrain profile for each of the plurality of non-towered airports. The “terrain profile” may indicate a comprehensive representation of a physical environment surrounding a non-towered airport. For example, the representation may include elevation data, obstacle information, runway characteristics, and significant geographical features that may impact flight operations. The terrain profile may be generated using various data sources, such as satellite imagery, LiDAR scans, and aggregated radio altimeter readings from aircraft.

In an example, the profile generation engine 312 may generate the terrain profile. The terrain profile may provide a detailed three-dimensional model of the landscape, incorporating both natural and man-made elements, to enhance pilots' understanding of the operational environment and support safe navigation at non-towered airports.

At block 910, the method 900 may include generating flight path for various phases of flight at each non-towered airport. The “flight path” may indicate a recommended trajectory for aircraft operations during various phases of flight at a non-towered airport. In an example, the flight path generation engine 312 may use the categorized data and terrain profiles to create optimized routes for approach, landing, taxi, take-off, and departure. The flight path generation engine 312 may consider factors, such as noise abatement procedures, obstacle clearance requirements, and efficient use of airspace.

At block 912, the method 900 may include storing the generated flight path in a database. In an example, the database may be designed to efficiently store and retrieve large volumes of flight path data. The flight path generation engine 316 may store the generated flight path in the cloud-based database. In an example, the flight path generation engine 316 may periodically refresh the stored flight paths based on new data inputs, such as recent flight operations or changes in airport conditions. The update frequency may be dynamically adjusted based on the rate of new data acquisition for each non-towered airport.

At block 914, the method 900 may include receiving a request for performing one of a landing and a take-off procedure by an aircraft. In an example, the receiving engine 412 may receive the request from an avionic system of the aircraft. The request may include aircraft data that may include performance parameters and operational parameters of the aircraft. As described above, the performance parameters may be indicative of capabilities of the aircraft and the operational parameters may be indicative of a current operational state of the aircraft. Further, the request may come through various communication channels, such as satellite-based communication systems, Very High Frequency (VHF) data links, ADS-B networks, and so on.

Further, at block 916, the method 900 may include based on the request, querying the database to retrieve data pertaining to the request received from the aircraft. The database may contain comprehensive data about non-towered airports, including runway lengths, widths, surface types, elevation, surrounding terrain, and historical weather patterns. In an example, the querying engine 414 may use advanced filtering techniques to quickly identify the most relevant flight paths and airport information based on the specific details provided in the request.

In case of the take-off procedure, the querying engine 414 may query the database to retrieve relevant information about the non-towered airport from where the aircraft needs to take-off and its surroundings. The relevant information may include runway characteristics, terrain data, obstacle information, current and forecasted weather conditions, and historical take-off patterns of similar aircraft from this airport.

In case of the landing procedure, the querying engine 414 may identify a set of compatible non-towered airports for the landing of the aircraft. The querying engine 414 may consider various parameters, such as distance from the aircraft's current position, runway length and width in relation to the aircraft's requirements, runway surface condition and type, surrounding terrain and obstacles, current and forecasted weather conditions, available emergency services in the vicinity, and historical flight paths of similar aircraft types at the airports. The querying engine 414 may then transmit the set of compatible non-towered airports to the aircraft's avionic system through the cloud network. A pilot of the aircraft may select a most suitable airport based on their assessment of the current situation and the provided information.

At block 918, the method 900 may include generating an operations map based on the retrieved data. The operations map may combine the retrieved flight paths with current operational data to create a customized visual representation of the recommended procedures. The operations map may include color-coded paths, waypoints, altitude restrictions, and annotations for important landmarks or potential hazards. In an example, the generation engine 416 may generate the operations map for the aircraft.

In case of the take-off procedure, the generation engine 416 may generate the operations map for the non-towered airport from where the aircraft is required to take-off. In case of the landing procedure, the generation engine 416 may generate the operations map for the non-towered airport selected by the pilot. In both the scenarios, the operations map may be generated based on the information retrieved from the clod-based database. The operations map may take into consideration the terrain profile or any obstacles associated with the non-towered airport.

At block 920, the method 900 may include transmitting the operations map to a display of an avionic system of the aircraft. In an example, the generation engine 416 may transmit the operations map to the aircraft. The transmission may be formatted to be compatible with various types of avionics displays, from traditional screens to advanced head-up displays or augmented reality systems.

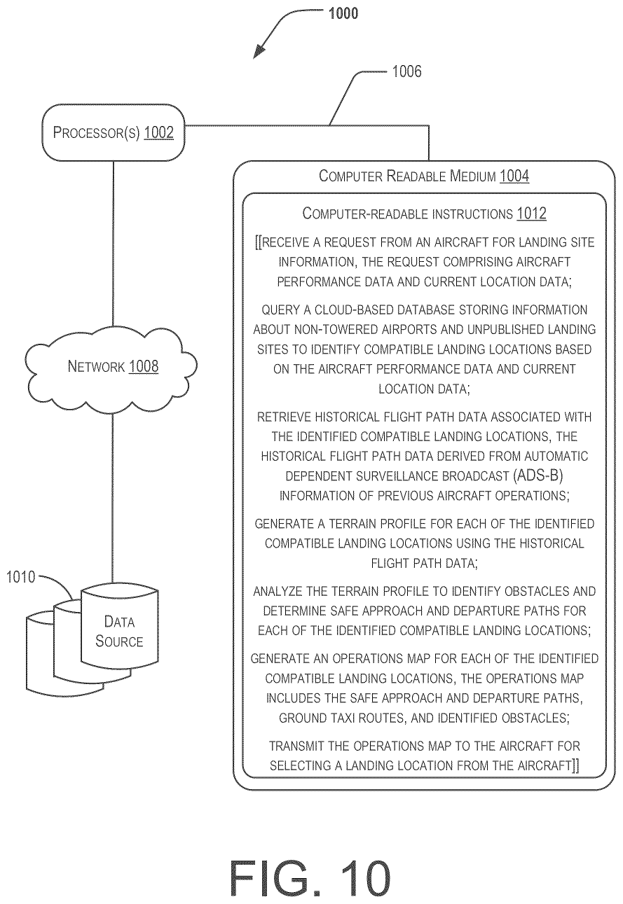

FIG. 10 illustrates a computing environment 1000 implementing a non-transitory computer-readable medium for generating operations map for assisting aircrafts at non-towered airports, according to an example. In an example, the computing environment 1000 includes processor(s) 1002 communicatively coupled to a non-transitory computer readable medium 1004 through a communication link 1006. In an example implementation, the computing environment 1000 may be for example, the system 100. In an example, the processor(s) 1002 may have one or more processing resources for fetching and executing computer-readable instructions from the non-transitory computer readable medium 1004. The processor(s) 1002 and the non-transitory computer readable medium 1004 may be implemented, for example, in system 100 (as has been described in conjunction with the preceding figures).

The non-transitory computer readable medium 1004 may be, for example, an internal memory device or an external memory device. In an example implementation, the communication link 1006 may be a network communication link. The processor(s) 1002 may access the non-transitory computer readable medium 1004 through a network 1008. The network 1008 may be a single network or a combination of multiple networks and may use a variety of communication protocols. The processor(s) 1002 and the non-transitory computer readable medium 1004 may also be communicatively coupled to a data source 1010 over the network 1008. The data source 1010 may include, for example, a repository.

In an example, the non-transitory computer readable medium 1004 includes a set of computer readable instructions 1012 (referred to as instructions 1012) which may be accessed by the processor(s) 1002 through the communication link 1006. Referring to FIG. 10, in an example, the non-transitory computer readable medium 1004 includes instructions 1012 that cause the processor(s) 1002 to perform operations for generating operations map for assisting aircrafts at non-towered airports. The operations map may refer to a visual representation of recommended procedures, routes, and operational information for aircraft operations at a specific non-towered airport or landing site. In an example, the processor 1002 may obtain a request from an aircraft for landing site information. The request may include aircraft performance data and current location data. In an example, the aircraft performance data may include factors such as aircraft type, weight, fuel state, maximum landing weight, required runway length, and crosswind limitations. Current location data may include the aircraft's position, altitude, heading, and speed.

Based on the request, the instructions 1012 may cause the processor(s) 1002 to query a cloud-based database storing information about non-towered airports and unpublished landing sites to identify compatible landing locations based on the aircraft performance data and the current location data. The cloud-based database may be continuously updated with new information from various sources, including ADS-B data, pilot reports, and satellite imagery analysis.

In an example, “unpublished landing sites” may refer to locations suitable for aircraft landing that are not officially designated as airports or listed in standard aeronautical publications. Such sites may include private airstrips, emergency landing areas, temporary landing zones, or other suitable terrain that has been previously used for aircraft landings but lacks formal recognition or regular maintenance as an airport. Unpublished landing sites may be identified through historical flight data, pilot reports, or analysis of terrain and obstacle data.

In addition, “compatible landing locations” may refer to landing sites, either published airports or unpublished landing sites, that meet the operational requirements of a specific aircraft based on its current performance capabilities and operational state. Compatibility may be determined by factors such as runway length, surface type, surrounding terrain, obstacles, current weather conditions, and the aircraft's weight, fuel state, and performance characteristics. A compatible landing location should allow for safe approach, landing, and potential take-off operations given the aircraft's current configuration and the environmental conditions at the site.

In response to the query, the instructions 1012 may cause the processor(s) 1002 to retrieve historical flight path data associated with the identified compatible landing locations. The historical flight path data derived from automatic dependent surveillance broadcast (ADS-B) information of previous aircraft operations. This historical data may include approach and departure paths, touchdown points, go-around patterns, and ground movement routes. The processor(s) 1002 may also incorporate data from other sources such as radar tracks, pilot reports, and onboard flight data recorders when available.

Additionally, the instructions 1012 may cause the processor(s) 1002 to generate a terrain profile for each of the identified compatible landing locations using the historical flight path data. The terrain profile may include elevation data, slope information, and surface characteristics. The processor(s) 1002 may utilize digital elevation models, satellite imagery, and LiDAR data to enhance the accuracy of the terrain profiles. In some cases, the terrain profile may be updated in real-time based on recent weather events or reported changes to the landing site.

The instructions 1012 may also cause the processor(s) 1002 to analyze the terrain profile to identify obstacles and determine safe approach and departure paths for each of the identified compatible landing locations. In an example, obstacle identification may include both natural features such as trees and hills, as well as man-made structures like buildings, towers, and power lines. The processor(s) 1002 may use computer vision algorithms to detect and classify obstacles from satellite imagery and other visual data sources. Safe approach and departure paths may be calculated considering factors such as obstacle clearance, noise abatement procedures, and local airspace restrictions.

In an example, analysing the terrain profile may include comparing the terrain profiles with pre-defined threshold values to identify potential obstacles. To compare the terrain profiles, the processor(s) 1002 may create a digital elevation model of the surrounding area and set altitude thresholds for different types of terrain features. Areas exceeding these thresholds may be flagged by the processor(s) 1002 as potential obstacles. Further, the processor(s) 1002 may simulate aircraft approach and departure trajectories based on the aircraft performance data and identified obstacles. This simulation may take into account various factors such as aircraft type, weight, speed, and climb/descent rates. The processor(s) 1002 may generate multiple potential trajectories for each runway or landing area, considering different wind conditions and approach angles. In addition, the processor(s) 1002 may adjust the simulated trajectories to maximize safety margins around the identified obstacles. For example, the processor(s) 1002 may iteratively modify the approach and departure paths to increase the vertical and horizontal separation from obstacles.

In an example, the instructions 1012 may cause the processor(s) 1002 to generate an operations map for each of the identified compatible landing locations. The operations map includes the safe approach and departure paths, ground taxi routes, and identified obstacles. The operations map may also include additional information such as wind direction indicators, recommended traffic patterns, emergency landing areas, and local landmarks for visual reference. The operations map may be customized based on the specific aircraft's performance capabilities and current operational state.

The instructions 1012 may further cause the processor(s) 1002 to analyze the historical flight path data to identify common holding patterns used by previous aircraft at each of the identified compatible landing locations. In the context of a non-towered airport, a holding pattern may be understood as an informal maneuver where pilots fly a repetitive path to maintain position and spacing relative to other aircraft or the airport itself. For example, the processor(s) 1002 may examine a large dataset of recorded flight paths, focusing on segments where aircrafts have maintained relatively constant altitude and position near the landing location, indicative of holding patterns.

Once common holding patterns are identified, the processor(s) 1002 may proceed to generate recommended holding patterns for each landing location. The generation of recommended holding patterns may involve synthesizing the most frequently observed patterns, optimizing for factors such as fuel efficiency, noise abatement, and compatibility with approach and departure paths. The recommended patterns may be tailored to different aircraft types or categories, taking into account their specific performance characteristics and operational requirements. After generating the recommended holding patterns, the processor(s) 1002 may incorporate this information into the operations maps for each landing location. These enhanced operations maps, now including the recommended holding patterns, are subsequently transmitted to aircraft that may potentially use these landing locations.

In an example, the instructions 1012 may cause the processor(s) 1002 to monitor real-time weather data for the identified compatible landing locations. Monitoring real-time weather data may involve continuously receiving and processing weather information from various sources, such as ground-based weather stations, satellite data, and other aircraft reports. The processor(s) 1002 may track parameters including but not limited to temperature, wind speed and direction, precipitation, visibility, and barometric pressure.

Further, the processor(s) 1002 may assess the impact of current weather conditions on one of the safe approach and departure paths. This assessment may involve analyzing how the observed weather conditions affect the previously determined safe paths. For instance, strong crosswinds may make certain approach angles less favorable, or low visibility might necessitate adjustments to the recommended descent profile. Based on this assessment, the processor(s) 1002 may dynamically update the operations map with weather-related advisories or path modifications. The updates may include altering the recommended approach or departure paths, adding warnings about turbulence or wind shear, or suggesting alternative landing sites if current weather conditions make the original location unsafe, and so on.

In an example, the instructions 1012 may cause the processor(s) 1002 to transmit the operations map to the aircraft for selecting a landing location from the aircraft. In an example, the transmission may occur via various communication channels such as satellite link, VHF data link, or cellular networks, depending on the aircraft's equipment and location. The operations map may be displayed on the aircraft's avionics system, electronic flight bag, or other compatible devices.

The instructions 1012 may further cause the processor(s) 1002 to receive feedback from the aircraft after landing. This feedback may include information about the actual landing experience, any discrepancies between the provided operations map and the real-world conditions, and suggestions for improvement. The processor(s) 1002 may use this feedback to refine and update its database, improving the accuracy of future operations maps.

Accordingly, the present subject matter may enhance aviation safety and operational efficiency at non-towered airports and unpublished landing sites by providing pilots with comprehensive, data-driven operations maps. By leveraging historical flight data, terrain analysis, and real-time information, the present subject matter generates customized approach and departure procedures tailored to specific aircraft capabilities and current conditions. This approach not only improves safety in routine operations but also expands the range of available landing options for pilots, potentially proving crucial in emergency situations. The ability to continuously refine the database ensures that the provided information remains accurate and relevant over time. Moreover, by seamlessly integrating with existing avionics systems and electronic flight bags, the present subject matter offers pilots intuitive access to critical landing information, thereby supporting more informed decision-making and safer operations in less structured airport environments.

Although examples for the present disclosure have been described in language specific to structural features and/or methods, it is to be understood that the appended claims are not necessarily limited to the specific features or methods described. Rather, the specific features and methods are disclosed and explained as examples of the present disclosure.

1. A system comprising:
a processor;
a memory; and
a machine-readable storage medium comprising instructions executable by the processor to:
receive aircraft data pertaining to one of a landing and a take-off procedure to be performed by an aircraft, the aircraft data comprising performance parameters and operational parameters of the aircraft, wherein the performance parameters are indicative of capabilities of the aircraft, and the operational parameters are indicative of a current operational state of the aircraft;
based on the received aircraft data, query a cloud-based database to retrieve historical flight path data associated with a particular non-towered airport from the cloud-based database, the cloud-based database is configured to store information pertaining to non-towered airports, wherein the historical flight path data is derived from flight information of previous aircraft operations at the particular non-towered airport;
generate an operations map for performing one of the landing and take-off procedures at the particular non-towered airport based on the historical flight path data and the aircraft data, wherein the operations map includes aerial and ground routes for maneuvering of the aircraft; and
render the generated operations map on a display of an avionic system of the aircraft.

2. The system as claimed in claim 1, wherein the cloud-based database includes historical flight path data derived from Automatic Dependent Surveillance-Broadcast (ADS-B) information of previous aircraft operations at the particular non-towered airport.

3. The system as claimed in claim 1, wherein to retrieve historical flight path data, the processor is to:
based on querying, generate a set of compatible non-towered airports for performing the landing procedure by the aircraft; and
transmit the set of compatible non-towered airports to the display of the avionic system of the aircraft.

4. The system as claimed in claim 3, wherein to generate the set of compatible non-towered airports, the processor is to filter the non-towered airport information based on one of a distance of the non-towered airports from an aircraft's current position, a runway length of the non-towered airports, and terrain characteristics of the non-towered airports.

5. The system as claimed in claim 3, wherein the processor is to:
identify one or more taxi paths at the particular non-towered airport based on the historical flight path data; and
render the identified taxi paths on the avionic system of the aircraft.

6. The system as claimed in claim 1, wherein to generate the operations map, the processor is to:
create a terrain profile associated with the particular non-towered airport;
compare the terrain profile with a pre-defined threshold value to determine an obstacle above the terrain profile; and
upon determination that the terrain profile is above the threshold value, generate the flight path for the non-towered airport.

7. The system as claimed in claim 1, wherein to generate the operations map the processor is to analyze the historical flight path data to identify common approach and departure patterns used by previous aircrafts at the particular non-towered airport.

8. The system as claimed in claim 1, wherein the cloud-based database is configured to receive and store landing site information for unpublished landing sites from at least one of an Automatic Dependent Surveillance-Broadcast (ADS-B) receiver, a radio altimeter, and an ADS-B flight tracking services.

9. The system as claimed in claim 1, wherein the processor is to:
monitor real-time flight data during one of the landing and the take-off procedures at particular the non-towered airport; and
dynamically adjust the generated operations map based on the real-time flight data.

10. A method comprising:
obtaining aviation data corresponding to a plurality of aircrafts operating at non-towered airports, the aviation data includes electronic altimeter data and historical data pertaining a flight path of the plurality of aircrafts;
segmenting the aviation data based one or more phases associated with the flight path of the plurality of aircrafts categorizing segmented data in each phase based on pre-defined parameters corresponding to the plurality of aircrafts; and
based on the segmented data, generating a flight path for each of the one or more phases at the non-towered airports, wherein the generated flight path is stored in a database for being provided to an aircraft for performing one of a landing and a take-off procedure at a selected non-towered airport.

11. The method as claimed in claim 10, wherein the method comprises updating the database after a pre-defined time period.

12. The method as claimed in claim 10, wherein generating the flight path comprises:
creating a terrain profile associated with a non-towered airport; and
comparing the terrain profile with a pre-defined threshold value to determine an obstacle above the terrain profile; and
upon determination that the terrain profile is above the threshold value, generate the flight path for the non-towered airport.

13. The method as claimed in claim 12, wherein creating the terrain profile comprises:
filtering the electronic altimeter data to remove noise from the radio altitude data for the non-towered airport; and
interpolating the flight path to fill gaps in the radio altitude data.

14. The method as claimed in claim 10, wherein the aviation data is obtained from one or more sources and the one or more sources comprises at least one of an ADS-B receiver and an ADS-B flight tracking service.

15. The method as claimed in claim 10, wherein the method comprises:
receiving a request from an avionic system of an aircraft for arrival at a non-towered airport, the request comprising information pertaining to the aircraft;
based on the information, extracting a set of non-towered airports from the database;
filtering the set of non-towered airports based on one or more parameters indicated in the request; and
rendering a final set of results on the avionic system.

16. The method as claimed in claim 10, wherein the historical flight data is Automatic Dependent Surveillance-Broadcast (ADS-B) data.

17. A non-transitory computer-readable medium comprising instructions, the instructions being executable by a processing resource of a system, to:
receive a request from an aircraft for landing site information, the request comprising aircraft performance data and current location data;
query a cloud-based database storing information about non-towered airports and unpublished landing sites to identify compatible landing locations based on the aircraft performance data and current location data;
retrieve historical flight path data associated with the identified compatible landing locations, the historical flight path data derived from Automatic Dependent Surveillance-Broadcast (ADS-B) information of previous aircraft operations;
generate a terrain profile for each of the identified compatible landing locations using the historical flight path data;
analyze the terrain profiles to identify obstacles and determine safe approach and departure paths for each of the identified compatible landing locations;
generate an operations map for each of the identified compatible landing locations, the operations map including the safe approach and departure paths, ground taxi routes, and identified obstacles; and
transmit the operations maps to the aircraft for selecting a landing location for the aircraft.

18. The non-transitory computer-readable medium of claim 17, wherein the instructions further cause the processing resource to:
analyze the historical flight path data to identify common holding patterns used by previous aircraft at each of the identified compatible landing locations;
generate recommended holding patterns for each landing location based on the analysis; and
include the recommended holding patterns in the operations maps transmitted to the aircraft.

19. The non-transitory computer-readable medium as claimed in claim 17, wherein the instructions, when executed by the processing resource, cause the processing resource to:
monitor real-time weather data for the identified compatible landing locations;
assess an impact of current weather conditions on one of the safe approach and departure paths; and
dynamically update the operations maps with weather-related advisories or path modifications.

20. The non-transitory computer-readable medium of claim 17, wherein analyzing the terrain profile comprises:
comparing the terrain profiles with pre-defined threshold values to identify potential obstacles;
simulating aircraft approach and departure trajectories based on the aircraft performance data and identified obstacles; and
adjusting simulated trajectories to maximize safety margins around the identified obstacles.
